(19) United States
(12) Patent Application Publication
(10) Pub. No.: US 2006/0218494 A1
(43) Pub. Date: Sep. 28, 2006

(54) Data transmission system

(75) Inventor: Kazuo Kitagawa, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: FUNAI ELECTRIC CO., LTD., Daito-shi (JP)

(21) Appl. No.: 11/387,969

(22) Filed: Mar. 24, 2006

(30) Foreign Application Priority Data
Mar. 25, 2005 (JP) 2005-087777

(51) Int. Cl. G06F 17/00

(52) U.S. Cl. 715/531

(57) ABSTRACT

Disclosed is a data transmission system including: a server device including a title data obtaining section which obtains title data from content providing section in which digital data containing AV data and title data thereof is stored; and a client device including: a title display controlling section which displays on outputting section the obtained title data; a title data storing section which stores title data; and a title data managing section which stores plural title data obtained from plural content providing sections in the title data storing section for each of the content providing section, wherein the server device and the client device communicate with each other through a transmission path, and the title data managing section, based on predetermined input operation information, allows the title display controlling section to display the titles stored in the title data storing section on the outputting section.

### BACKGROUND OF THE INVENTION

1. Field of the Invention

The present invention relates to a data transmission system capable of transmitting AV data (video data and audio data) with high bit rates through a wireless transmission path. More specifically, the present invention relates to a data transmission system capable of efficiently obtaining and displaying title data from a plurality of content providing sections.

2. Description of Related Art

In recent years, DVD/HDD recorders or personal computers have been remarkably widespread. Accompanying this tendency, video properties capable of being privately viewed at home are also increasing. Further, it is desired to freely enjoy viewing at any required time or place the contents such as video information stored in DVD/HDD recorders or personal computers. Therefore, there is proposed a technology for enabling the contents to be outputted to client devices such as TV sets or personal computers using a home network. For a technology for transmitting vast quantities of data such as video data or audio data at high speed-in real time, for example, IEEE 1394 is adopted for an interface for connecting digital TV sets or digital videos.

Further, for simplifying the connection between devices, a wireless LAN has been recently used to allow connection of DVD/HDD recorders, personal computers or LCD monitors. For a typical technology using the wireless LAN, IEEE 802.11 standardized in IEEE is adopted, and a technology of using 2.4 GHz band becomes mainstream. The 2.4 GHz band is referred to as an ISM (Industrial, Scientific and Medical) band and is a frequency band used in an industrial, medical or household microwave oven. In Japan, a frequency band from 2.400 to 2.497 GHz is allocated to a wireless LAN.

A data transmission system utilizing the above-described wireless LAN is configured by connecting between an AV source device (content providing section) such as a DVD/HDD recorder and a server device, and by connecting between outputting section such as an LCD monitor and a client device, thereby performing transmission of data such as video data via wireless communication between the server device and the client device. In such a data transmission system, remote control operation of the DVD/HDD recorder is performed to the client devices, so that the DVD/HDD recorder can be controlled through the server device. For example, information (e.g., a title of the AV data recorded in media) of the content providing section can be displayed on outputting section and further, when performing a predetermined input operation in this display screen, desired AV data can be easily played.

For technologies for allowing information transmitted from content providing section to be displayed on this outputting section, for example, the following documents are disclosed. That is, JP 2003-174598A discloses an information processor in which a plurality of data strings can be inputted from a plurality of input sources (content providing section) to allow images respectively corresponding to the plurality of data strings to be simultaneously displayed. Further, WO 00/01191A discloses a technology that in an AVC system including a plurality of AV devices connected with each other through a transmission path, a controller with user interface is allowed to display operating screen information of a device as a controlling object.

The above-described wireless transmission system has an advantage that wirings between devices can be omitted. On the contrary, the system has a defect that as compared with a case of directly wired-connecting the content providing section and the outputting section, data transmission process is complicated and therefore, a reaction rate to a remote control operation in the client device side is reduced (delay occurs). Further, in a case of using a plurality of content providing sections, only information from one enabled content providing section can be displayed on outputting section. Specifically, when switching of the content providing section to be enabled as well as display of desired information is not required from the client device, information from other content providing section cannot be displayed. Therefore, a wasting time is required for users, and moreover, an input operation from the remote controller becomes complicated.

### SUMMARY OF THE INVENTION

It is one of objects of the present invention to provide a data transmission system in which title data from a plurality of content providing sections can be efficiently obtained and displayed through a wireless transmission path as well as users can reduce a load due to input operations.

According to a first aspect of the invention, a data transmission system comprises: a server device comprising a title data obtaining section which obtains title data from content providing section in which digital data containing AV data and title data corresponding to the AV data is stored; and a client device comprising: a title display controlling section which displays on outputting section the title data obtained by the title data obtaining section; a title data storing section which stores title data; and title data managing section which stores a plurality of title data obtained from a plurality of content providing sections in the title data storing section for each of the content providing section, wherein the server device and the client device communicate with each other through a transmission path, and the title data managing section, based on predetermined input operation information, allows the title display controlling section to display the plurality of titles stored in the title data storing section on the outputting section.

Preferably, the title data obtaining section monitors the title data stored in the content providing section and, when the title data is updated in the content providing section, obtains the title data. Herein, the wording “the title data is updated” represents for example that DVD media is exchanged in a DVD recorder or the like, or a program is recorded to a hard disk in a HDD recorder or the like. For example, the exchange of DVD media can monitor by monitoring operation of a DVD player, and the recording of a program on a HDD can monitor by monitoring titles which are recorded to the HDD in predetermined intervals.

Preferably, the title data contains command data for playing AV data corresponding to the title data, and the client device further comprises a playback controlling section which, based on received predetermined input operation information, transmits the playback command data to the server device so as to require playback of corresponding AV data. By doing so, users can easily play the AV data corresponding to a desired title and therefore, can reduce a load due to the input operation from the remote controller.

Preferably, the title data managing section, based on received predetermined input operation information, allows the title display controlling section to display the plurality of titles stored in the title data storing section on the same screen of the outputting section. By doing so, the titles stored in the plurality of content providing devices can be confirmed on the same screen. As a result, users can easily select the titles to be played.

Preferably, the server device is connected to the plurality of content providing sections. By doing so, the system constitution can be simplified, because it is not necessary to provide one on one the content providing device and server device.

According to a second aspect of the invention, a video signal processor comprises: title display controlling section which displays, on outputting section, title data obtained from a plurality of content providing sections in which digital data containing AV data and title data corresponding to the AV data is stored; title data storing section which stores the title data; and title data managing section which stores a plurality of title data obtained from the plurality of content providing section in the title data storing section for each of the content providing section, wherein the title data managing section, based on received predetermined input operation information, allows the title display controlling section to display the plurality of titles stored in the title data storing section on the outputting section.

According to the present invention, in the data transmission system configured such that the server device and the client device can communicate with each other through a transmission path, the client device comprises title data storing section which can store the title data, and title data managing section which stores a plurality of title data obtained from a plurality of content providing sections in the title data storing section for each of the content providing section. The title data managing section, on the basis that predetermined input operation information is received, allows the plurality of titles stored in the title data storing section to be displayed on the outputting section by the title display controlling section. Therefore, even if switching of the content providing section to be enabled is not required from the client device, desired information can be instantaneously displayed. As a result, a display time of the title data can be shortened as well as an input operation from a remote controller can be simplified.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein;

FIG. 1 is a schematic construction view of a data transmission system according to the present embodiment;

FIG. 2 is a schematic construction view of a server device 20;

FIG. 3 is a schematic construction view of a client device 30;

FIG. 4 is one display example of a title menu displayed on an output device 40;

FIG. 5 is a flowchart showing a title data obtaining process; and

FIG. 6 is a flowchart showing a title data displaying process.

### DETAILED DESCRIPTION OF THE INVENTION

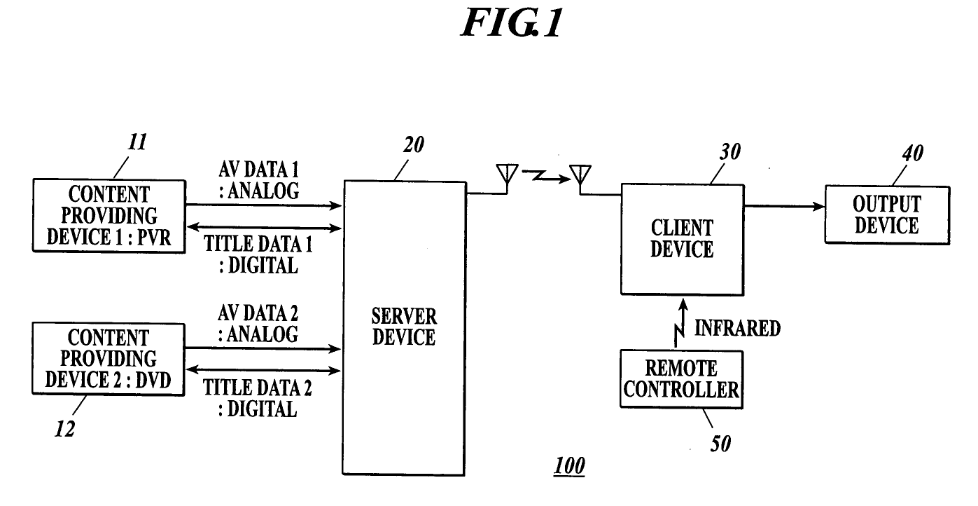

Preferred embodiments of the present invention will be described below by referring to drawings. FIG. 1 is a schematic construction view of a data transmission system according to the present embodiment.

A data transmission system 100 according to the present embodiment is composed of content providing devices 11 and 12 which provides contents (analog data or digital data) containing video data and audio data, a server device 20, a client device 30 and an output device 40 such as an LCD monitor. In the present embodiment, the system 100 is configured such that two content providing devices 11 and 12 of a PVR 11 and DVD recorder 12 such as a hard disk recorder are connected to the server device 20.

In the data transmission system 100, for example, connection between the server device 20 and each of the content providing devices 11 and 12 is performed through a predetermined cable. Further, AV data as an analog signal and title data as a digital signal are supplied to the server device 20 from the content providing devices 11 and 12. Herein, the system 100 may be configured such that also the AV data is supplied as a digital signal.

In the content providing devices 11 and 12, for example, digital AV data compression-coded in accordance with the MPEG 2 system and title data corresponding to the AV data are stored. This title data contains, for example, text data and command data for playing corresponding AV data. Further, the content providing devices 11 and 12 have an AV data forming section (not shown). The devices 11 and 12 read out contents (video data and audio data) from recording media such as a hard disk or DVD and then convert the contents into a predetermined format to output the contents as analog AV data.

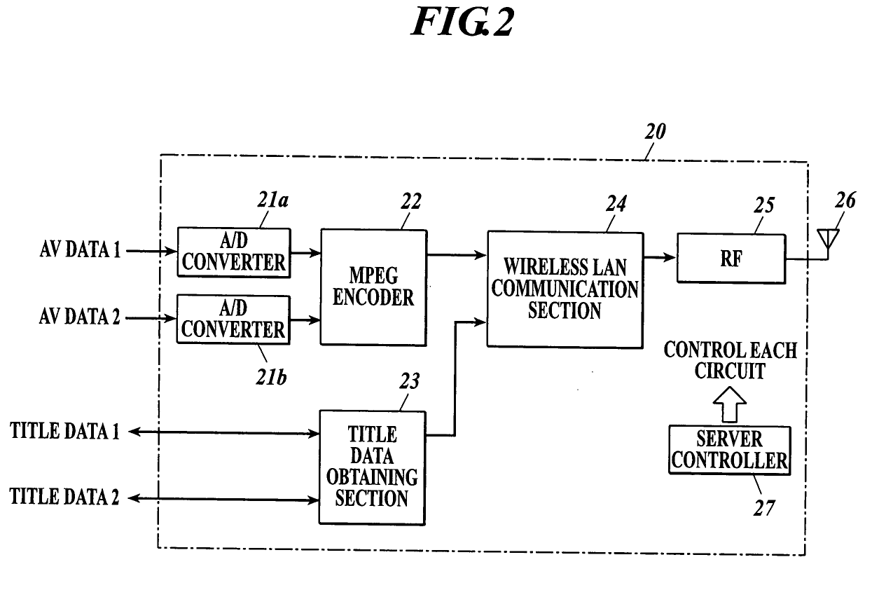

FIG. 2 is a schematic construction view of the server device 20. As shown in FIG. 2, the server device 20 has A/D converters 21a and 21b, an MPEG encoder 22, a title data obtaining section 23, a wireless LAN communication section 24, a high-frequency amplifier 25, an antenna 26 and a server controller 27. The server device 20 transmits AV data 1 and 2 as well as title data 1 and 2 supplied from the content providing devices 11 and 12 to the client device 30 in an MPEG2 transport stream format.

The A/D converter 21a converts the analog AV data transmitted from the content providing device 11 into digital data. The A/D converter 21b converts the analog AV data transmitted from the content providing device 12 into digital data. The MPEG encoder 22 compression-codes, in accordance with an MPEG2 scheme, the digital AV data supplied from the A/D converters 21a and 21b.

The title data obtaining section 23 obtains, from the content providing devices 11 and 12, the title data 1 and 2 respectively corresponding to the AV data 1 and 2. Herein, the title data obtaining section 23 is configured so as to monitor the title data stored in the content providing devices 11 and 12 and, when the title data is updated in the content providing devices 11 and 12, obtains the title data. For example, the section 23 monitors the title data recorded in a hard disk at a predetermined time interval and, when program is newly recorded in the content providing device (PVR) 11, obtains the title data. Further, the section 23 monitors a switching action in a disk tray of the content providing device (DVD) 12 and, when it is determined that DVD media are exchanged, obtains the title data.

The wireless LAN communication section 24 performs protocol processing and modulation-demodulation processing on the digital data outputted from the MPEG encoder 22 and the title data obtaining section 23. The high frequency amplifier 25 amplifies a high frequency component of RF signals and transmits the amplified signals to the client device 30 through the antenna 26. For example, through a communication channel with a frequency band of which the center frequency is 2.412 GHz, the amplifier 25 transmits the RF signals.

The server controller 27 is composed of a CPU, RAM and ROM (not shown). The ROM stores various control programs, and the CPU operates according to the control program within the ROM while using the RAM as a work area. For example, when receiving an AV data playback request from the client device 30, the server controller 27 reads out the corresponding AV data from the content providing devices 11 and 12, and controls each circuit to allow the AV data to be transmitted to the client device 30.

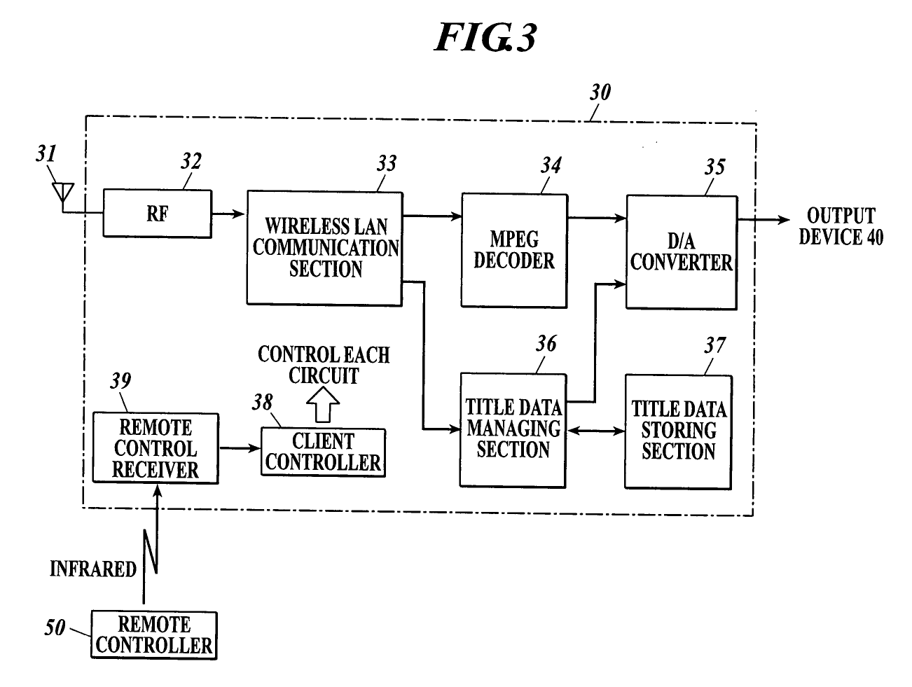

FIG. 3 is a schematic construction view of the client device 30. As shown in FIG. 3, the client device 30 has an antenna 31, a high-frequency amplifier 32, a wireless LAN communication section 33, an MPEG decoder 34, a D/A converter 35, a title data managing section 36, a title data storing section 37, a client controller 38 and a remote control receiver 39. The device 30 receives the digital data transmitted from the server device 20 and outputs the data to the output device 40.

The antenna 31 receives RF signals transmitted through the communication channel from the server device 20 and supplies the received RF signals to the high-frequency amplifier 32. The high-frequency amplifier 32 amplifies a high frequency component of RF signals received by the antenna 31 and supplies the amplified RF signals to the wireless LAN communication section 33. The wireless LAN communication section 33 performs protocol processing and modulation/demodulation processing on the digital data supplied from the high-frequency amplifier 32.

The MPEG decoder 34 expansion-decodes the digital AV data supplied from the wireless LAN communication section 33. The D/A converter 35 analog-converts the digital AV data supplied from the MPEG decoder 34 or the title data supplied from the title data managing section 36 and then outputs the analog data to the output device 40.

The title data managing section 36 stores the title data supplied from the wireless LAN communication section 33 in the title data storing section 37 for each of the content providing devices. Specifically, the section 36 stores the title data 1 as title data from the content providing device 11 and stores the title data 2 as title data from the content providing device 12. Further, the section 36, on the basis that input operation information on a title list display is received from the remote controller 50, allows the plurality of titles stored in the title data storing section 37 to be displayed on the output device 40 by the title display controlling section.

The remote control receiver 39 receives signals (e.g., infrared rays) transmitted from the remote controller 50 operated by users.

The client controller 38 is composed of a CPU, RAM and ROM (not shown). The ROM stores various control programs, and the CPU operates according to the control programs within the ROM while using the RAM as a work area. For example, the section 38 serves as the above-described title display controlling section. Further, the section 38, on the basis that the remote control receiver 39 receives from the remote controller 50 the input operation information on playback, serves as playback controlling section which transmits playback command data contained in the title data to the server device 20 to thereby require playback of corresponding AV data.

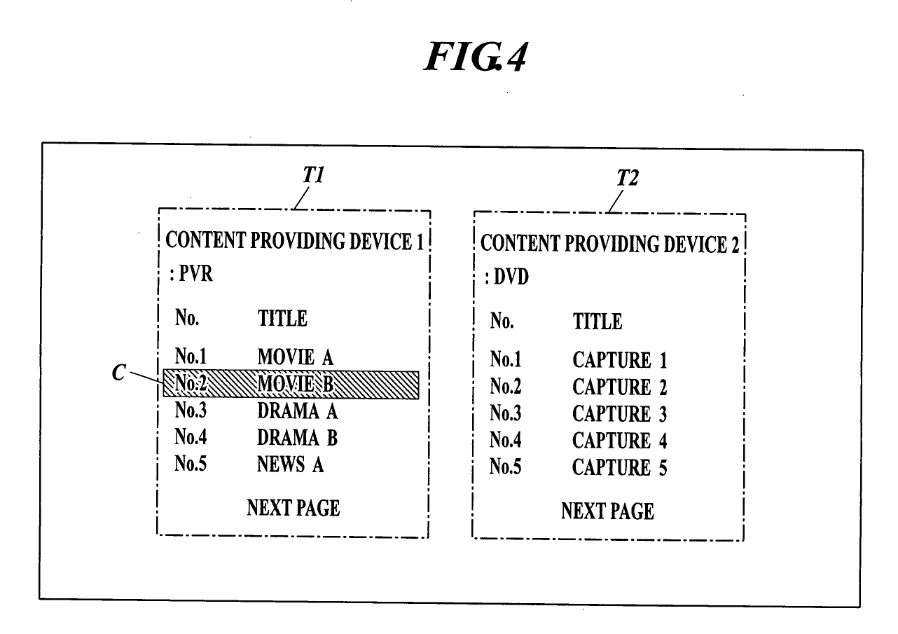

FIG. 4 is one display example of a title menu displayed on the output device 40. As shown in FIG. 4, the titles T1 and T2 corresponding to the AV data stored in the content providing devices 11 and 12 are simultaneously displayed on the output device 40. In a conventional technology, the title data can be obtained only from the enabled content providing device. Therefore, there can be displayed either the title T1 corresponding to the AV data stored in the content providing device 11 or the title T2 corresponding to the AV data stored in the content providing device 12.

Further, in the title menu shown in FIG. 4, when moving a cursor C to a desired title (“movie B” in FIG. 4) to perform an input operation of the Play button using the remote controller 50, users can play the AV data corresponding to the title.

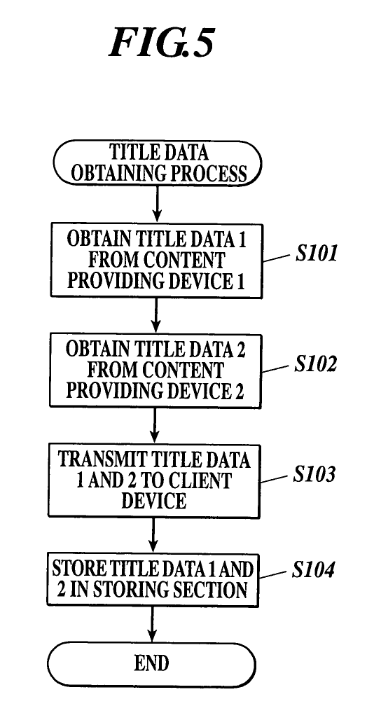

FIG. 5 is a flowchart showing process control in obtaining the title data from the content providing devices 11 and 12.

First, in the server device 20, the title data obtaining section 23 obtains the title data 1 from the content providing device 11 (step S101). Next, the title data obtaining section 23 obtains the title data 2 from the content providing device 12 (step S102).

Next, the section 23 transmits the title data 1 and 2 to the client device 30 (step S103). Further, in the client device 30, the title data managing section 36 stores the title data 1 and 2 in the title data storing section 37 (step S104).

Thus, the title data corresponding to the AV data stored in the content providing devices 11 and 12 is stored in the title data storing section 37. For example, the above-described title data obtaining process is performed when the power sources of the server device 20 and the client device 30 are turned on. Thereafter, the obtaining process is further performed when the title data stored in the content providing devices 11 and 12 is updated.

In the flowchart of FIG. 5, after obtaining the title data 1 and 2, these data is simultaneously transmitted to the client device 30. Further, the title data may be transmitted to the client device 30 every time the title data is obtained.

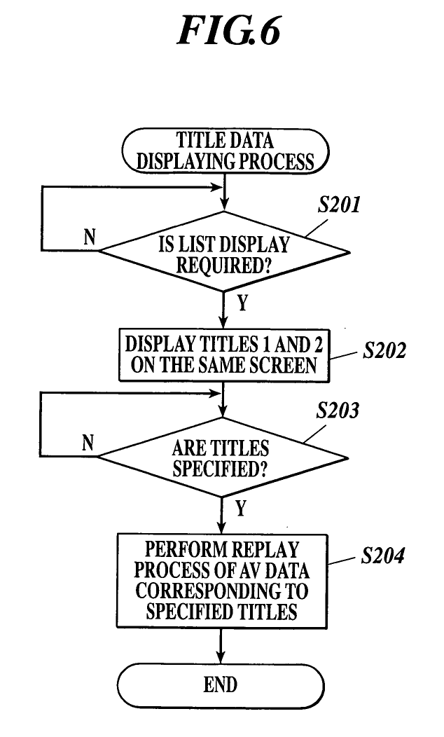

FIG. 6 is a flowchart showing process control in displaying the title data on the output device 40.

First, in the client device 30, it is determined whether display of the title list is required, specifically, whether an input operation for displaying the title list is performed from the remote controller 50 (step S201). When it is determined that the display of the title list is required, the title data 1 and 2 corresponding to the AV data stored in the content providing devices 11 and 12 is simultaneously displayed on the output device 40 (step S202). At this time, the title menu shown in FIG. 4 is displayed on the output device 40.

Subsequently, it is determined whether the title is specified in this title list display menu, specifically, whether an input operation for selecting and playing the title is performed from the remote controller 50 (step S203). Further, when it is determined that the title is specified, playback process of the AV data corresponding to the specified title is performed (step S204). In other words, the client device 30 transmits to the server device 20 the playback command data contained in the title data of the selected title to thereby request playback of corresponding AV data. Then, the device 30 receives and plays the relevant AV data sent back from the server device 20.

Thus, in the present embodiment, the client device 30 comprises title data storing section 37 which can store title data, and title data managing section 36 which stores a plurality of title data 1 and 2 obtained from a plurality of content providing sections 11 and 12 in the title data storing section 37 for each of the content providing section 11 and 12. Further, the title data managing section 36, on the basis that predetermined input operation information is received from the remote controller 50, allows the plurality of titles 1 and 2 stored in the title data storing section 37 to be displayed on the output device 40. Therefore, even if switching of the content providing device to be enabled is not required from the client device 30, desired information (e.g., a title list) can be instantaneously displayed. As a result, a display time of the title list can be shortened as well as an input operation from the remote controller 50 can be simplified.

Further, users can easily play the AV data corresponding to a desired title and therefore, can reduce a load due to the input operation from the remote controller 50. Further, the title data managing section 36, on the basis that the input operation information from the remote control device 50 is received, allows the plurality of titles stored in the title data storing section 37 to be simultaneously displayed on the output device 40 by the title display controlling section. Therefore, the titles stored in the plurality of content providing devices 11 and 12 can be confirmed on the same screen. As a result, users can easily select the titles to be played.

The invention performed by the present inventor is described in detail above with reference to the embodiment. The present invention is not limited to the above-described embodiment, and alterations can be made therein as appropriate without departing from spirit and scope of the inventions.

For example, in the above embodiment, the wireless LAN with a 2.4 GHz band specified by IEEE 802.11g is described. In addition thereto, other transmission technologies can also be used. For example, a wireless LAN with a 5.2 GHz band specified by IEEE 802.11a, a wireless LAN with a 2.4 GHz band specified by IEEE 802.11b or an optical wireless LAN can be used. Further, the present embodiment can be applied not only to a case of using wireless transmission technology but also to a case of using wire-line transmission technology.

Further, in the above embodiment, a system configuration in which two content providing devices 11 and 12 are connected to the server device 20 is described. Further, a system configuration in which three or more content providing devices are connected to a server device can also be used. Alternatively, a server device may be installed for each content providing device to allow title data to be transmitted to one client device from a plurality of server devices.

The entire disclosure of Japanese Patent Application No. 2005-0087777 filed on Mar. 25, 2005, including description, claims, drawings and summary are incorporated herein by reference.

What is claimed is:

1. A data transmission system comprising:
a server device comprising a title data obtaining section which obtains title data from a plurality of content providing sections in which digital data containing AV data and title data corresponding to the AV data are stored; and
a client device comprising:
a title display controlling section which displays on an outputting section the title data obtained by the title data obtaining section;
a title data storing section which stores title data containing command data for playing corresponding AV data;
a title data managing section which stores a plurality of title data obtained from a plurality of content providing sections in the title data storing section for each of the content providing section; and
a playback controlling section which, based on received predetermined input operation information, transmits the playback command data to the server device so as to require playback of corresponding AV data,
wherein the server device and the client device communicate with each other through a transmission path,
the title data obtaining section monitors the title data stored in the content providing section and, when the title data is updated in the content providing section, obtains the title data, and
the title data managing section, based on received predetermined input operation information, allows the title display controlling section to display the plurality of titles stored in the title data storing section on the same screen of the outputting section.

2. A data transmission system comprising:
a server device comprising a title data obtaining section which obtains title data from content providing section in which digital data containing AV data and title data corresponding to the AV data is stored; and
a client device comprising:
a title display controlling section which displays on outputting section the title data obtained by the title data obtaining section;
a title data storing section which stores title data; and
a title data managing section which stores a plurality of title data obtained from a plurality of content providing sections in the title data storing section for each of the content providing section,
wherein the server device and the client device communicate with each other through a transmission path, and
the title data managing section, based on predetermined input operation information, allows the title display controlling section to display the plurality of titles stored in the title data storing section on the outputting section.

3. The data transmission system according to claim 2, wherein the title data obtaining section monitors the title data stored in the content providing section and, when the title data is updated in the content providing section, obtains the title data.

4. The data transmission system according to claim 2,
wherein the title data contains command data for playing AV data corresponding to the title data, and
the client device further comprises a playback controlling section which, based on received predetermined input operation information, transmits the playback command data to the server device so as to require playback of corresponding AV data.

5. The data transmission system according to claim 2, wherein the title data managing section, based on received predetermined input operation information, allows the title display controlling section to display the plurality of titles stored in the title data storing section on the same screen of the outputting section.

6. The data transmission system according to claim 2, wherein the server device is connected to the plurality of content providing sections.

7. A video signal processor comprising:
title display controlling section which displays, on outputting section, title data obtained from a plurality of content providing sections in which digital data containing AV data and title data corresponding to the AV data is stored;
title data storing section which stores the title data; and
title data managing section which stores a plurality of title data obtained from the plurality of content providing section in the title data storing section for each of the content providing section,
wherein the title data managing section, based on received predetermined input operation information, allows the title display controlling section to display the plurality of titles stored in the title data storing section on the outputting section.
